(19) United States
(12) Patent Application Publication
(10) Pub. No.: US 2013/0197466 A1
(43) Pub. Date: Aug. 1, 2013

(54) ADAPTER DEVICE FOR REDUCING OR ELIMINATING THE POTENTIAL BACTERIAL CONTAMINATION IN A PROCESS OF EXTRACTION OR TRANSFER OF BLOOD COMPONENTS FROM AT LEAST ONE CONTAINER

(71) Applicant: BIOTECHNOLOGY INSTITUTE, I MAS D, S.L., Vitoria (Alava) (ES)

(72) Inventor: Eduardo ANITUA ALDECOA, Vitoria (Alava) (ES)

(73) Assignee: BIOTECHNOLOGY INSTITUTE, I MAS D, S.L., Vitoria (Alava) (ES)

(21) Appl. No.: 13/754,414

(22) Filed: Jan. 30, 2013

(30) Foreign Application Priority Data
Jan. 30, 2012 (ES) P201200084

(51) Int. Cl. A61J 1/14

(52) U.S. Cl. CPC A61J 1/1443
USPC 604/405; 604/414

(57) ABSTRACT

An adapter device (1) for reducing or eliminating the potential bacterial contamination in a process of extraction or transfer of blood components from at least one container (3) to a recipient or any applicable destination, thereby increasing user safety, that comprises a body (2) provided with at least one first area (2a) designed to be approached or attached to at least one container (3) and at least one second area (2b) designed to remain accessible to the exterior, and at least one needle (7) that projects from each first area (2a) and is capable of piercing a pierceable area (3a) of a container (3). The needle (7) presents an inner tube (8) that communicates with an inner tube (9) of the body (2), which in turn leads to an opening (4) in a second area (2b), and at least one flexible part (10) that maintains each inner tube (9) of the body (2) closed.

### TECHNICAL FIELD

The invention refers to an adapter device for reducing or eliminating the potential bacterial contamination in a process of extraction or transfer of blood components from at least one container to a recipient or any applicable destination.

### PRIOR ART

Methods for preparing blood compounds with desirable biological properties, as for example the method disclosed in U.S. Pat. No. 6,569,204, carry a certain risk of infection for the patient, as said methods usually involve a first step in which blood is extracted from the patient and/or a latter step of administering the final blood compound to the patient. The risk of contamination arises from the fact that some of the stages of said methods are not immune from bacterial contamination. Bacterial contamination may occur due to a variety of reasons: due to a septicaemia that sends germs into the vascular stream (which may occur when there is need to extract blood from the patient at an initial stage, or when the patient is treated with the final blood compound), due to an inadequate disinfection of the skin at the instant when the vein is punctured (in those methods that require the extraction of blood from the patient), or due to having to manipulate blood and subsequent compounds while the method is being performed.

In regard to the manipulation of blood components, a risk factor of bacterial contamination is the fact that the methods are often performed in open containers, i.e. in containers that are not air-tight or vacuum-sealed. Therefore, in these methods the blood components come into contact with the surrounding air (methods being known as “open circuit” methods). In other cases it may occur that although the method is basically performed in closed containers, it becomes necessary at some point to open a container that contains blood components, thus resulting in a bacterial contamination risk of said blood components. An example of this type of situation is one in which a method is performed in closed containers, but in a given moment it is necessary to open the container in order to transfer part or all of its content to another container. This occurs, for example, when commercial extracting devices are used, usually in the form of syringes, as described in patents ES2364733, U.S. Pat. No. 3,906,947 or U.S. Pat. No. 7,077,826, for extracting blood components from a container. The use of these devices generally requires the opening of the container for introducing the device in order to be able to easily extract the blood components.

In the event that it is necessary to open a container in order to extract part or all of the blood components it contains to a recipient or any other applicable destination, a more secure alternative method of action is known, with regards to the potential bacterial contamination of the blood components. This method is based on having the extraction performed in an appropriate environment (e.g. a laminar flow chamber, a sterile environment or a surgery room). Unfortunately, the installation of special equipment in order to create an appropriate environment often entails a high cost for the user, in terms of adapting the medical installations in order to allow the method to be performed.

The objective of the present invention is to provide a cost-effective device for reducing the bacterial contamination in a process of extraction or transfer of blood components from a container to a recipient or any applicable destination (e.g. another container, the body of a syringe or any other extraction device).

Another objective of the invention is to ensure the optimal safety of the user that performs the extraction or transfer from the containers.

### BRIEF DESCRIPTION OF THE INVENTION

In order to meet at least one of the previous objectives, an adapter device is proposed for reducing or eliminating the potential bacterial contamination in a process of extraction or transfer of blood components from at least one container, which is provided with a pierceable area, to a recipient or any applicable destination. The device comprises a body that is provided with at least one first area designed to be approached or attached to at least one container, and at least a second area designed to remain accessible to the exterior. At least one needle projects from each first area designed to pierce the pierceable area of a container. The needle presents an inner tube that communicates with an inner tube of the body, which in turn leads into an opening in the second area. The adapter device is also provided with at least one flexible part that maintains each inner tube of the body closed.

This means that the adapter device according to the invention may be connected to one or more containers, in a way that at least one needle pierces the pierceable area of each container. Thus, through the needle's inner tube and the corresponding inner tube of the body of the adapter device, the container's interior is rendered communicable to the exterior, with the exception that a flexible part maintains said communication closed.

The first step to extract or transfer part or all of the content of a container or several containers to a recipient or any applicable destination is to connect the container or containers to the device, in a way that at least one needle pierces each pierceable area of each container. Since the flexible parts of the device maintain the inner tubes closed, the containers remain sealed (except for an optional venting system as described below) and no potentially contaminating air is able to enter. Next, in order to extract or transfer part or all of the content of each container, the user must simply introduce a transfer or extraction medium into the inner tube of the device and pass it through the inner tube of the needle until it reaches the interior of the container.

Thus, it is not necessary that the extraction device have a sharp tip; instead it will suffice that its tip is able to pass through the flexible part. This guarantees the safety of the user during handling of the device, since there is no risk of being pricked by the tip of the transfer or extraction device.

In addition, as proved, the invention allows the transfer or extraction of components from the container without the need to open it, and thus guarantees a permanent sealing, which, among other benefits, prevents medical staff from coming in contact with the blood components inside the container, thus reducing the risk of said medical staff being contaminated. An additional advantage is that the step of extracting from the adapter device can be performed by using syringes or other commercial extraction devices, it not being necessary to use a specialized extraction device.

The adapter may be manufactured for connecting to a single container or to several containers simultaneously.

### BRIEF DESCRIPTION OF THE DRAWINGS

Details of the invention are depicted in the accompanying figures, which are intended to be illustrative and non-limiting:

FIG. 1 shows a perspective of a first embodiment of the adapter device according to the invention, connected to two containers.

FIG. 2 shows a different perspective of the assembly shown in the previous figure.

FIG. 3 shows a cross-sectional view of part of the assembly shown in the previous figures.

FIG. 4 shows a very schematic front view of a second embodiment of the adapter device according to the invention, about to be connected to three containers.

### DETAILED DESCRIPTION OF THE INVENTION

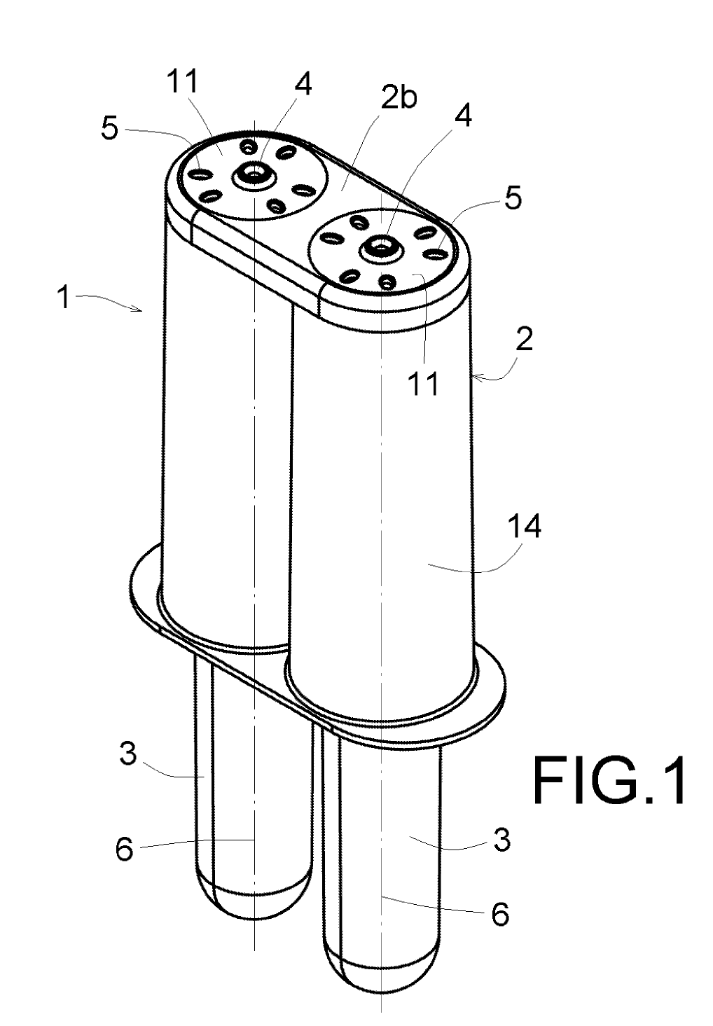

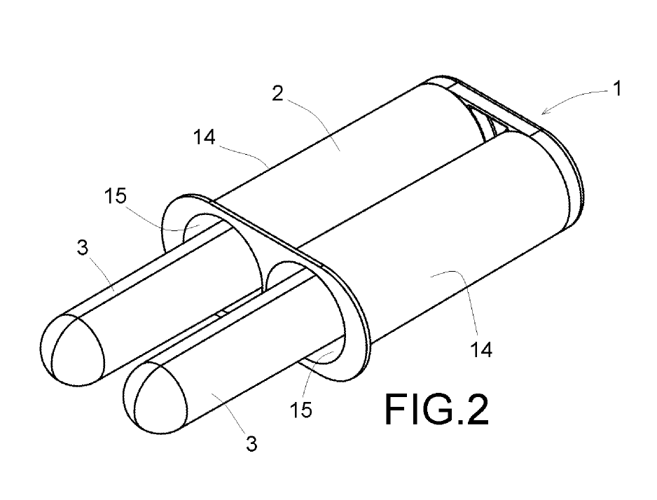

FIGS. 1 and 2 show two perspectives of a first embodiment of the adapter device according to the invention, which in this case is able to be connected to two containers. As can be observed, the adapter device (1) comprises a body (2) that is attached to two containers (3), which in this embodiment remain partially concealed within the adapter device (1). The exterior area is provided with openings (4) that allow the insertion of extraction or transfer media that will be able to access the interior of the containers (3), as explained below. The exterior area also presents air flow areas (5), the function of which is explained below.

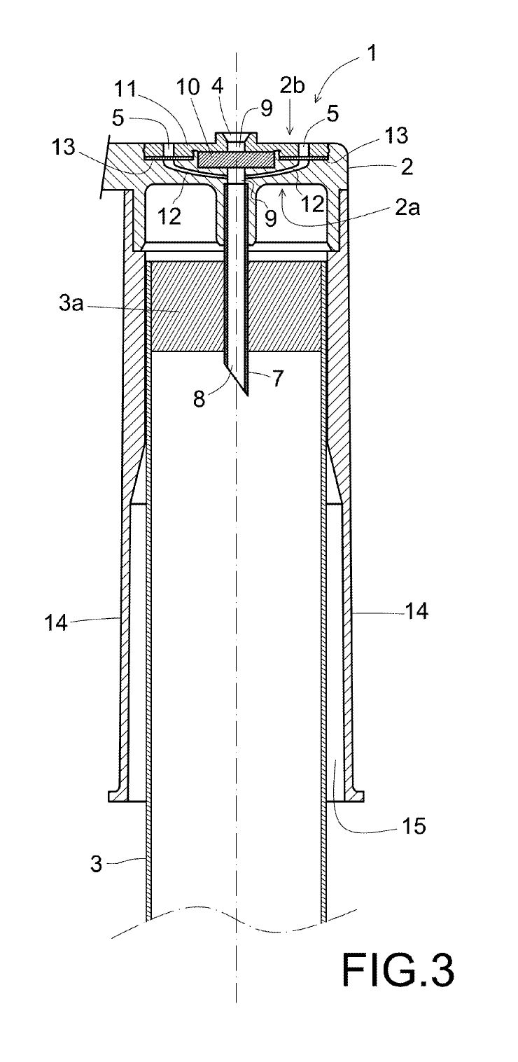

FIG. 3 shows a cross-sectional view of part of the assembly shown in the previous figures, according to a section plane containing the longitudinal axes (6) of the containers (3). As can be observed, the body (2) of the adapter device (1) is provided with at least one first area (2a) designed to be approached or attached to at least one container (3)—in this case, two containers—and at least one second area (2b) designed to remain accessible to the exterior. The adapter device (1) also comprises at least one needle (7) that projects from each first area (2a) and that is designed to pierce the pierceable area (3a) of a container (3). The needle (7) presents an inner tube (8) that communicates with an inner tube (9) of the body (2), which in turn leads into an opening (4) in a second area (2b), in a way that the container's interior is rendered communicable to the exterior by means of both tubes (8, 9). In addition, the adapter device (1) comprises at least one flexible part (10) that is arranged so that it closes each inner tube (9) of the body (2). This flexible part (10) prevents the blood components inside the container (3) from being contaminated when said container (3) is attached to the corresponding needle (7) of the adapter device (1).

Thus, when it becomes necessary to extract blood components from the interior of a container (3) that is already attached to the adapter device (1), a needle of an extraction device (e.g. the needle of a syringe) is inserted through the opening (4) and through the flexible part (10); said opening (4) guides the needle of the extraction device towards the inner tube (8) of the needle (7) of the adapter device (1) in a very simple manner. In this process of inserting the extraction device, the flexible part (10) adjusts itself perfectly around the shape of the needle of the extraction device, thus preventing contaminated air from entering into the container (3), ensuring this way that the adapter device (1) remains sealed.

Optionally, the adapter device (1) comprises at least one detachable cover (11), which conceals at least one flexible part (10). By way of example, the embodiment represented in FIGS. 1 and 2 comprises two covers (11), one for each container (3), that conceal the respective flexible parts (10). The respective flexible parts (10) become visible once the corresponding cover (11) has been removed. This facilitates the fitting of the flexible parts (10) as well as their replacement if needed. Each cover (11) comprises an outlet opening (4) of the inner tube (9) of the body (2) of the adapter device (1).

Optionally, the adapter device (1) comprises a venting system. More specifically, the adapter device (1) comprises at least one air flow area (5, 12) that allows air to pass from the exterior to the inner tube (9) of the body (2). A porous element (13) is located in said air flow area (5, 12) for filtering the air that flows towards the inner tube (9). This venting system allows non-contaminated air to enter the inner tube (9) for maintaining an atmospheric pressure inside said inner tube (9) and the interior of the container (3), thus preventing that the transfer of blood components from the interior of the container (3) is stopped as a result of a decreased pressure in said interior.

In the represented embodiment, the porous element (13) is arranged around the flexible part (10), more specifically as a surrounding ring. This constitutes a simple and effective constructive solution for providing several air flow areas (5) per needle (7).

In this case, in which the porous element (13) is arranged around the flexible part (10), the adapter device (1) may comprise a detachable cover (11) that conceals one or more porous elements (13), which would become visible once the cover (11) is removed. This facilitates the fitting of the porous element (13) as well as its replacement if needed. The cover (11) comprises at least one air flow area (5) arranged towards the porous element (13), allowing the exterior air to enter the interior of the container (3) free of bacterial contamination due to the filtering performed by the porous element (13).

In the represented embodiment, the same cover (11) conceals both the flexible part (10) and the porous element (13) associated with each container (3).

This allows optimizing the number of components or parts comprised in the adapter device (1).

In addition, it is preferable that the adapter device (1) comprises at least side walls (14) that define an inner space (15) designed to receive each container (3). The needles (7) remain located inside said inner space (15). The availability of side walls (14) that define said inner spaces (15) for inserting and housing the containers (3) allows for a more intuitive use of the adapter device (1). In addition, the fact that the needles (7) are located inside said inner spaces (15) allows for an increased safety for the user as it lowers the risk of being pricked by the needles (7).

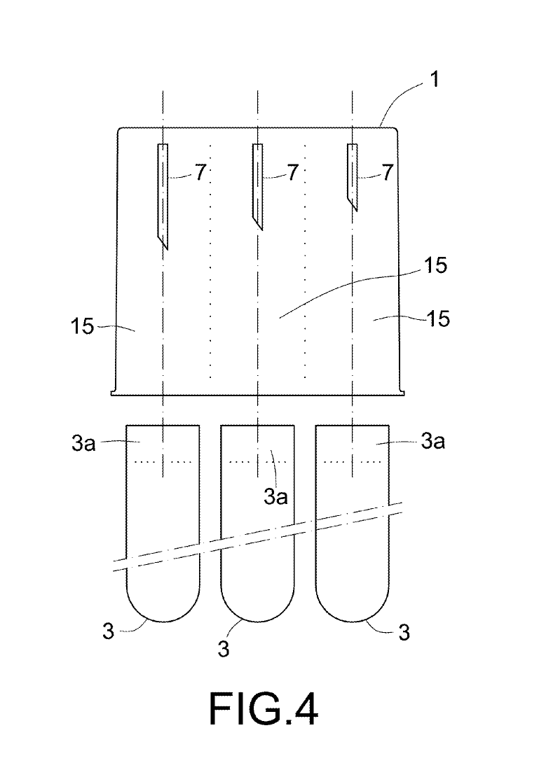

If the adapter device (1) is configured to be connected to more than one container, the needles (7) designed to pierce the pierceable area (3a) of each container (3) may optionally present varying lengths for facilitating the connection of the adapter device (1). FIG. 4 provides an illustration of this technical option. Said figure shows an adapter device (1) provided with three inner spaces (15) and three respective needles (7), in order to be connected to three containers (3). In the represented embodiment, the needles (7) present a decreasing length so that when the container set (3) is inserted, i.e. when all three containers (3) are inserted at the same time, the pierceable areas (3a) of the containers (3) are not pierced simultaneously but successively. This reduces the force to be exerted by the user on the adapter device (1) for piercing the containers (3).

In addition, if the adapter device (1) is configured to be connected to more than one container, the same porous element (13) may be shared by more than one container (3), in a way that the same porous element (13) allows air to pass from the exterior to one or more inner tubes (9) that communicate with their respective needles (7). In this case, an air flow area (12) shall be extended from each respective inner tube (9) to the shared porous element (13).

1. An adapter device (1) for reducing or eliminating the potential bacterial contamination in a process of extraction or transfer of blood components from at least one container (3) to a recipient or any applicable destination, where the container (3) is provided with a pierceable area (3a), characterized in that it comprises:
a body (2) provided with at least one first area (2a) capable of being approached or attached to at least one container (3) and at least one second area (2b) capable of remaining accessible to the exterior,
at least one needle (7) that projects from each first area (2a) and is designed to pierce the pierceable area (3a) of a container (3), where the needle (7) presents an inner tube (8) that communicates with an inner tube (9) of the body (2), which in turn leads to an opening (4) in the second area (2b),
at least one flexible part (10) that maintains each inner tube (9) of the body (2) closed.

2. The adapter device (1) according to claim 1, characterized in that it comprises at least one detachable cover (11) that partially conceals at least one flexible part (10), said flexible part (10) becoming visible once the cover (11) is removed, with said cover (11) comprising an opening (4).

3. The adapter device (1) according to claim 1, characterized in that it further comprises at least one air flow area (5, 12) that allows air to pass from the exterior to the inner tube (9) of the body (2), where in said air flow area (5, 12) is located a porous element (13) for filtering the air that flows towards the inner tube (9).

4. The adapter device (1) according to claim 3, characterized in that the porous element (13) is arranged around the flexible part (10).

5. The adapter device (1) according to claim 3, characterized in that it comprises at least one detachable cover (11) that conceals at least one porous element (13), said porous element (13) becoming visible once the cover (11) is removed, with said cover (11) comprising at least one air flow area (5) towards the porous element (13).

6. The adapter device (1) according to claim 5, characterized in that the cover (11) further conceals at least one flexible part (10).

7. The adapter device (1) according to claim 1, characterized in that it comprises at least one side wall (14) that defines an inner space (15) designed to receive a container (3), with at least one needle (7) located inside said inner space (15).

8. The adapter device (1) according to claim 1, characterized in that the needles (7) designed to pierce the pierceable area (3a) of each container (3) present varying lengths for facilitating the connection of the adapter device (1) to more than one container (3).
